(19) United States
(12) Patent Application Publication
(10) Pub. No.: US 2025/0112300 A1
(43) Pub. Date: Apr. 3, 2025

(54) BATTERY WITH PATHWAY

(71) Applicant: Apple Inc., Cupertino, CA (US)

(72) Inventors: Depeng Wang, San Jose, CA (US); Angus S. Smith, San Jose, CA (US); Hirotsugu Oba, Sunnyvale, CA (US); Junhua Liu, Hayward, CA (US)

(73) Assignee: Apple Inc., Cupertino, CA (US)

(21) Appl. No.: 18/374,412

(22) Filed: Sep. 28, 2023

(51) Int. Cl. H01M 50/103; H01M 10/42; H01M 50/54; H01M 50/55; H01M 50/557

(52) U.S. Cl. CPC H01M 50/103; H01M 10/425; H01M 50/54; H01M 50/55; H01M 50/557; H01M 2010/4271

(57) ABSTRACT

A battery, comprising a battery can housing including a main portion and a ledge that extends from a sidewall of the main portion at a transverse angle to the sidewall, an electrode stack housed within the main portion, and an electrical contact electrically coupled to the electrode stack. A portion of the electrical contact extends from the ledge at the transverse angle to the sidewall.

### CROSS-REFERENCES TO RELATED APPLICATIONS

This application is related to the following concurrently filed and commonly assigned U.S. nonprovisional patent application:
U.S. nonprovisional patent application Ser. No. ______, Filed ______, 2023, “BATTERY WITH LAMINATED ELECTRODE TAB”, (Attorney Docket No. 090911-P44691US2-1399722),

### BACKGROUND

As electronic devices develop in functionality, there is a commensurate demand to decrease the size of the electronic devices. At the same time, there is a demand for the electronic device to maintain a certain level of battery performance. However, the size of the electronic device may be limited by the position and orientation of the components housed in the electronic device. Accordingly, a need exists to configure the components of an electronic device to minimize the size of the electronic device while maximizing the energy provided by a battery housed within the electronic device.

### BRIEF SUMMARY

One aspect of the disclosure provides for a battery, comprising a battery can housing including a main portion and a ledge that extends from a sidewall of the main portion at a transverse angle to the sidewall, an electrode stack housed within the main portion, and an electrical contact electrically coupled to the electrode stack. A portion of the electrical contact extends from the ledge at the transverse angle to the sidewall. The ledge may include a plateau portion and a valley portion and the plateau portion may include a greater height from a base of the battery can housing than the valley portion. The battery may further comprise being a second electrical contact. The electrical contact may be a first electrical contact, the first electrical contact may extend from a first aperture defined by the plateau portion, the second electrical contact may extend from a second aperture defined by the valley portion. The sidewall may include a first maximum length greater than a second maximum length of the ledge. The ledge may extend from an intermediate portion of the sidewall. The ledge may be a first ledge of a plurality of ledges. The ledge may extend from a corner of the main portion

Another aspect of the disclosure provides for a battery, comprising a battery can housing including a main portion and a ledge that extends from a sidewall of the main portion at a transverse angle to the sidewall, an electrode stack housed within the main portion, and an electrode tab electrically coupled to the electrode stack. A portion of the electrode tab extends from the ledge at the transverse angle to the sidewall. The ledge may include a plateau portion and a valley portion and the plateau portion may include a greater height from a base of the battery can housing than the valley portion. The battery may further comprise a second electrode tab. The electrical contact may be a first electrode tab, the first electrode tab may extend from a first aperture defined by the plateau portion, and the second electrode tab may extend from a second aperture defined by the valley portion. The sidewall may include a first maximum length greater than a second maximum length of the ledge. The ledge may extend from an intermediate portion of the sidewall. The ledge may be a first ledge of a plurality of ledges. The ledge may extend from a corner of the main portion.

Another aspect of the disclosure provides for a battery system, comprising a battery. The battery comprises a battery can housing including a main portion and a ledge that extends from a sidewall of the main portion at a transverse angle to the sidewall, an electrode stack housed within the main portion, and a conductive component electrically coupled to the electrode stack, wherein a portion of the conductive component extends from the ledge at the transverse angle to the sidewall. A battery management unit is electrically coupled to the conductive component The battery system may further comprise an electronic component electrically coupled to the conductive component and positioned on the ledge at the transverse angle to the sidewall. The battery system may further comprise a second conductive component. The ledge may include a plateau portion and a valley portion. The plateau portion may include a greater height from a base of the battery can housing than the valley portion. The conductive component may be a first conductive component that may extend from a first aperture defined by the plateau portion, and the second conductive component may extend from a second aperture defined by the valley portion. The sidewall may include a first maximum length greater than a second maximum length of the ledge. The ledge may be a first ledge of a plurality of ledges. The ledge may extend from a corner of the main portion.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 depicts a simplified, cross-sectional, top view of an example electronic device according to an aspect of the disclosure.

FIG. 2A depicts a perspective view of an example battery according to an aspect of the disclosure.

FIG. 2B depicts a cross-sectional view of the battery of FIG. 2A.

FIG. 3A depicts a perspective view of an example battery according to an aspect of the disclosure.

FIG. 3B depicts a side view of the battery of FIG. 3A.

FIG. 4 depicts a simplified, top view of an example battery according to an aspect of the disclosure.

FIG. 5 depicts a simplified, top view of an example battery according to an aspect of the disclosure.

FIG. 6 depicts a simplified, top view of an example battery according to an aspect of the disclosure.

FIG. 7 depicts a simplified, top view of an example battery according to an aspect of the disclosure.

FIG. 8 depicts a simplified, top view of an example battery according to an aspect of the disclosure.

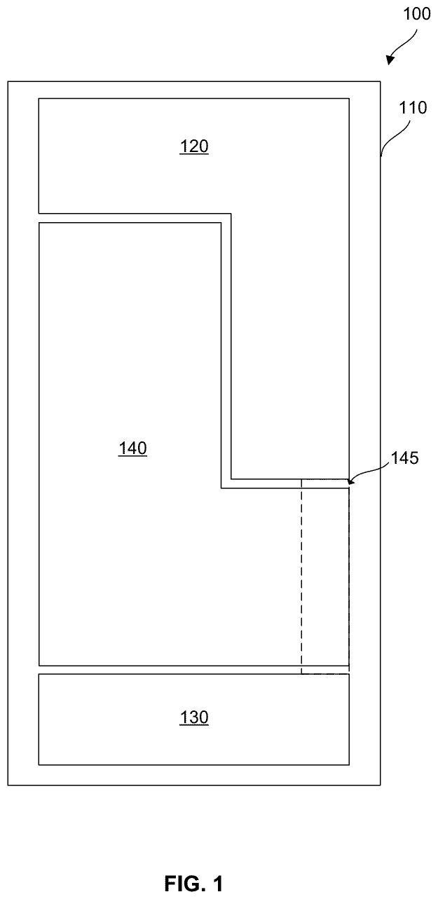

### DETAILED DESCRIPTION OF THE INVENTION

The present disclosure is directed to a battery having a pathway defined by a ledge extending transverse to a sidewall of the battery. Electrode tabs may extend from electrode cells (e.g., an electrode cell stack) housed within the battery and from the ledge while being in line with the ledge. Such a configuration allows for other components of an electronic device (e.g., a battery management unit (BMU), printed circuit board (PCB), or the like) to be coupled to the electrode tabs while positioned within the pathway defined between the extension sidewall and the battery sidewall. This configuration may allow for the overall size of the electronic device to be reduced.

In some embodiments, the electrode tabs may extend from the sidewall to lie flat against the sidewall (i.e., in a parallel orientation with the sidewall) of the battery. In these embodiments, the pathway for components to couple to the tabs would lie flat against the sidewall such that these components would also lie flat against the sidewall. This configuration correlates the overall thickness of the electronic device and the width of these components positioned along the clearance area so that the thickness of the electronic device would be limited by the width of these components, and vice versa. In other words, the electronic device cannot be thinner than the width of such components and the width of the components cannot be smaller than the thickness of the battery.

The battery of the present disclosure addresses these issues by defining a pathway between a sidewall and a ledge extending from the sidewall at a transverse angle. The electrode tabs may extend from the ledge at a similar transverse angle to the sidewall. For example, where the ledge and electrode tabs are substantially orthogonal to the sidewall, components may be stacked horizontally on the ledge in the pathway. In this configuration, the overall thickness of the electronic device may be decreased as the thickness of the battery is no longer limited by a width of the components. Accordingly, the battery of the present disclosure may provide for a thinner electronic device.

As discussed above, in other embodiments, the size and orientation of the electronic components may be tied to the size and orientation of the battery. This, in turn, may limit how small the electronic device can be. Specifically, because electronic components are coupled against a sidewall of the battery housing, the size of the electronic components and the battery housing are limited by each other (e.g., the battery housing cannot have a height smaller than a thickness of the electronic components, and vice versa). To address this issue, the battery 140 may define a pathway 145 that allows for one or more path electronic components (not shown) to electrically couple the first electronic component group 120, the second electronic component group 130, and the battery 140 together (e.g., to send signals or power to each other, or the like). These path electronic components may include one or more of a PCB, BMU, wires, or the like. As will be discussed further below, the pathway 145 may be defined between a ledge extending from the battery housing and a sidewall of the battery housing such that that path electronic components can be positioned on the ledge of the battery 140 rather than against the sidewall of the battery 140. In this manner, the electronic component groups 120, 130 and the battery 140 may be electrically coupled together without tying the size and orientation of the electronic components to the battery 140.

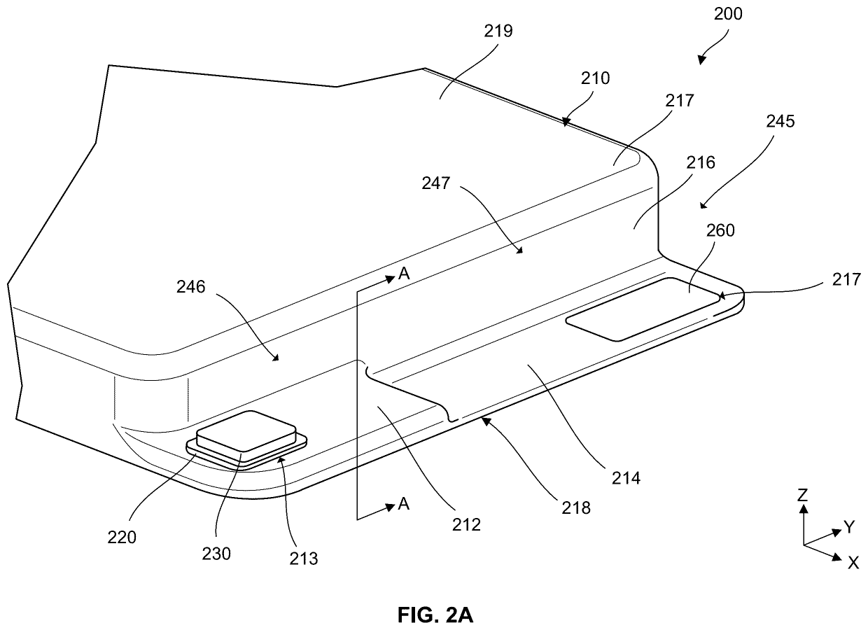

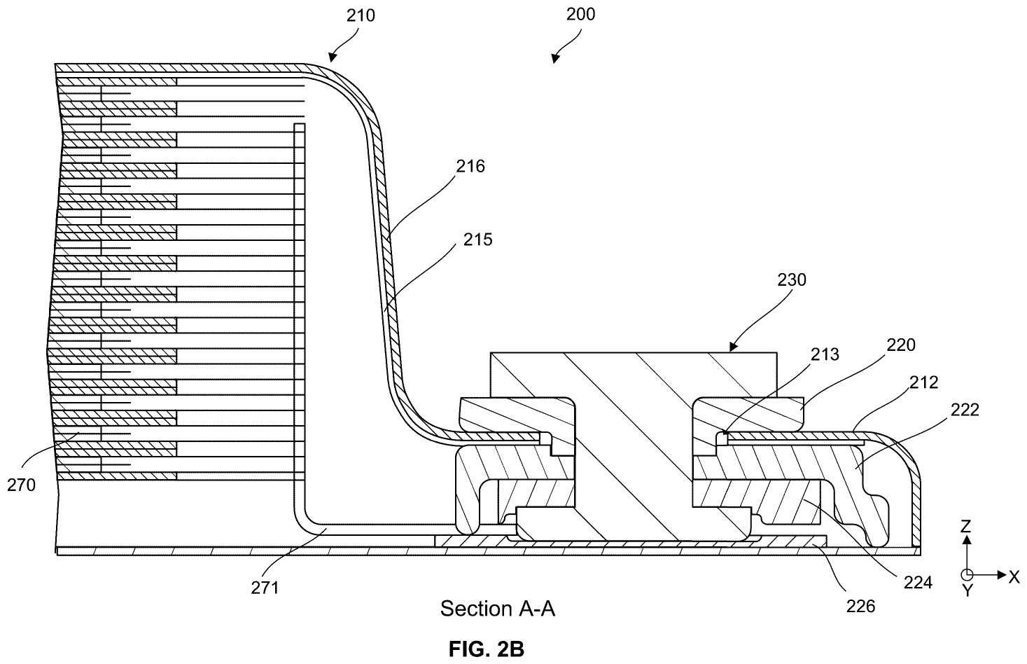

FIGS. 2A and 2B depict an example battery 200. FIG. 2A depicts a perspective view of an example battery according to an aspect of the disclosure. FIG. 2B depicts a cross-sectional view of the battery of FIG. 2A. It is understood that features ending in like reference numerals as features discussed above are similar, except as noted below. The battery 200 may include a battery housing 210 housing an electrode stack 270. As will be discussed further below, the electrode stack 270 may provide power to one or more components of an electronic device through a first electrical contact 230 extending through a first aperture 213 defined by the battery housing 210. The first electrical contact 230 may be a rivet having flared ends, however, in other embodiments, the first electrical contact may have other geometric shapes, such as being cuboid, spherical, pyramidal, cylindrical, irregular geometries, or the like. The battery may include a second electrical contact 260 (e.g., a negative electrode tab coupled to a ground source) extending through a second aperture 217 defined by the battery housing 210. In other embodiments, the second electrical contact 260 may be ground to the battery housing, rather than extending through the second aperture to couple with a ground source. The battery housing 210 can be one or more components coupled together (e.g., via welding, bonding, glue, fastening, or the like) to house the electrode stack 270. The battery housing 210 can be a battery can housing for prismatic battery cells. The battery housing 210 may be any material that can provide protection to the electrode stack 270, such as aluminum, stainless steel, carbon fiber, or the like. In some examples, the material of the battery housing 210 may be selected to have conductive properties.

The battery housing 210 may include a ledge 218 extending from a sidewall 216 of the battery housing 210 along the X-direction. The ledge 218 may include a plateau portion 212 and a valley portion 214. Each of the portions 212, 214 may house one or more components that facilitate electrical communication with the electrode stack 270. For example, the plateau portion 212 may house an outer gasket 220, inner gasket 222, an internal electrical contact 224, spacer 226, and electrical contact 230. The valley portion 214 may house a second electrical contact 260. In other embodiments, the second electrical contact may not be a part of the ledge and, instead, may be coupled elsewhere along the battery housing. In other embodiments, the valley portion may house the first electrode contact, such as a rivet, and the plateau portion may house the second electrical contact, such as a negative electrode tab. Although the plateau portion 212 extends higher along the Z-axis than the valley portion 214 (e.g., from a base of the battery housing 210), in other embodiments, the valley portion may extend higher along the Z-direction than the plateau portion or may have an equal height to the plateau portion. Although FIGS. 2A and 2B depict the plateau and valley portions to have a cuboid geometry, each of the plateau and valley portions may have the same or different shapes. For example, the plateau and valley portions may have any shapes, such as a spherical shape, pyramidal shape, cylindrical shape, irregular geometries, or the like.

In other embodiments, the ledge may include any number of plateau portions or valley portions, such as two or more plateau portions and/or two or more valley portions. For example, the ledge may include two plateau portions positioned at opposite ends of the ledge and a valley portion positioned therebetween. Alternatively, the ledge may include two valley portions positioned at opposite ends of the ledge and a plateau portion positioned therebetween. In another example, the ledge may include multiple plateau and valley portions arranged in series (e.g., a plateau portion at an end of the ledge followed by a valley portion, followed by another plateau portion and another valley portion, etc.) In this example, the opposite end of the ledge may end in either a plateau portion or a valley portion. In other examples, this series configuration may start with a valley portion at the end of the ledge.

The ledge 218 and the sidewall 216 may define a pathway 245 therebetween. The pathway 245 may be similar to the pathway 145, as discussed above, by allowing for one or more path electronic components (e.g., one or more of a PCB, BMU, wires, or other electronic components) to be electrically coupled together with the electrode stack 270. In particular, the sidewall 216 and the plateau portion 212 may define a first portion 246 of the pathway 245, and the sidewall 216 and the valley portion 214 may define a second portion 247 of the pathway 245. Each of the portions 246, 247 of the pathway 245 may correspondingly provide a space for one or more electronic components to pass over the ledge 245. In some embodiments, the first portion 246 may receive one or more electronic components different than those received by the second portion 247. For example, as discussed further below, the additional height provided in the second portion 247 between the valley portion 214 and a top surface 219 of the battery housing 210 may accommodate one or more additional components than the space provided in the first portion 246 between the plateau portion 212 and the top surface 219.

FIG. 2B depicts, in greater detail, the components coupling the electrode stack 270 and the first electrical contact 230. In particular, the electrode stack 270 may be electrically coupled to the first electrical contact 230 via a conductive component 271 and an internal electrical contact 224 (e.g., through compression, conductive adhesive, or the like). The conductive component 271 may include one or more electrically conductive materials, such as aluminum, copper, nickel, or the like. The conductive component 271 may be a current collector or a part of a current collector made of an electrically conductive material. The conductive component 271 may be electrically coupled to an internal electrical contact 224. The internal electrical contact 224 may also be made of an electrically conductive material. In this manner, the electrode stack 270 may provide an electrical charge that flows from the electrode stack 270, to the conductive component 271, to the internal electrical contact 224, and to the first electrical contact 230. One or more components may be coupled to the electrical contact 230 to receive this electrical charge.

The first electrical contact 230 may be a conductive material. In some embodiments, the first electrical contact 230 may be a rivet that extends from an internal volume of the ledge 218 through a first aperture 213 defined by the battery housing 210 to exterior the ledge 218. In this manner, a portion of the electrical contact 230 extends exterior to the battery housing 210 for one or more electrical components to couple to.

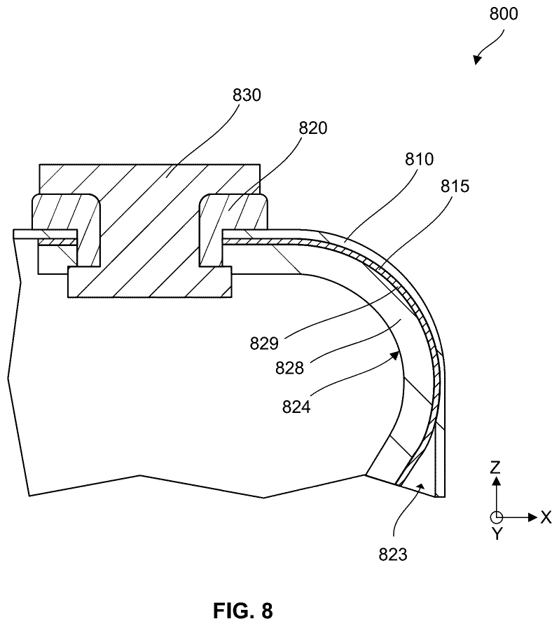

The battery 200 may include an external gasket 220 and an internal gasket 222. The gaskets 220, 222 may include an electrically insulative material, such as rubber, plastic (e.g., polybutylene (PB), perfluoroalkoxy (PFA), polypropylene, and/or polybutylene succinate (PBS)), or the like. The internal gasket 222 may be received entirely within the battery housing 210. The internal electrical contact 224 may be compressed between the electrical contact 230 and the internal gasket 222 along the Z-direction to ensure that the electrical contact 230 is in contact with the internal electrical contact 224. The external gasket 220 may be partially received in the aperture 213, and coupled between the electrical contact 230 and an exterior surface of the battery housing 210. The gaskets 220, 222 may be positioned between the electrical contact 230 and internal electrical contact 224 to prevent the electrical contact 230 and the internal electrical contact 224 from contacting the battery housing 210. In this manner, the gaskets 220, 222 may electrically insulate the battery housing 210 from the electrical charge transferred from the electrode stack 270 to the conductive component 271, internal electrical contact 224, and the electrical contact 230. In other embodiments, the plateau may house more or less components than depicted in FIG. 2B. For example, the conductive component, internal electrical contact, and the internal gasket may be replaced by an internal electrode tab including a conductive layer and an insulated lamination layer, as discussed further below with FIG. 8.

The battery housing 210 may additionally include an internal lining 215 at least partially lining an interior surface of the battery housing 210. The internal lining 215 may include an electrically insulative material. In particular, the internal lining 215 may line the interior surface of the battery housing 210 around the aperture 213 to provide an additional layer of electrical insulation between the electrical contact 230 and the battery housing 210. Accordingly, the internal lining 215 may further mitigate the risk that the electrical charge from the electrode stack 270 is transferred to the battery housing 210.

The battery housing 210 may include a spacer 226 positioned below the electrical contact 230 along the Z-direction. The spacer 226 may include an electrically insulative material. The spacer 226 may assist in pushing the electrical contact 230 against the internal electrical contact 224 to ensure contact between the electrical contact 230 and the internal electrical contact 225. The spacer 226 may additionally provide an insulative buffer between the electrical contact 230 and the battery housing 210 to mitigate the risk that that the electrical charge from the electrode stack 270 is transferred to the battery housing 210.

The transverse angle of the ledge 218 from the sidewall 216 may be related to the transverse angle of the spacer 226, gaskets 220, 222, and electrical contact 230 to the sidewall 216. Accordingly, the position and orientation of the spacer 226, gaskets 220, 222, and first electrical contact 230 may also be oriented in a similar transverse angled to the sidewall 216. This configuration facilitates the benefits provided by the ledge 218 because the position of these features allows for pathway electrical components to be electrically coupled to the electrode stack 270 while stacked on the ledge 218 in an orientation transverse to the sidewall 216. Although the ledge 218 (and the corresponding spacer 226, gaskets 220, 222, and electrical contact 230) are substantially orthogonal to the sidewall 216, in other embodiments, these features may be at a transverse angle to the sidewall as desired, such as at an angle less or greater than 90° (e.g., 45°, 135°, or the like).

The electrode stack 270 may include one or more components. For example, the electrode stack 270 may include one or more of a cathode active material, anode active material, and a separator. In some embodiments, the cathode and anode active materials may be separated from each other by the separator. The cathode active material may include aluminum, stainless steel, or other suitable metals, as well as a non-metal material including a polymer. For example, the cathode active material may be a lithium-containing material. In some embodiments, the lithium-containing material may be a lithium metal oxide, such as lithium cobalt oxide, lithium manganese oxide, lithium nickel manganese cobalt oxide, lithium nickel cobalt aluminum oxide, or lithium titanate, while in other embodiments the lithium-containing material can be a lithium iron phosphate, or other suitable materials that can form a cathode in a battery cell. The anode active material may include copper, stainless steel, or any other suitable metal, as well as a non-metal material including a polymer. For example, the anode active material may be silicon, graphite, carbon, a tin alloy, lithium metal, a lithium-containing material, such as lithium titanium oxide (LTO), or other suitable materials that can form an anode in a battery cell.

The active materials may additionally include an amount of electrolyte in a completed cell configuration. The electrolyte may be a liquid including one or more salt compounds that have been dissolved in one or more solvents. The salt compounds may include lithium-containing salt compounds in embodiments, and may include one or more lithium salts including, for example, lithium compounds incorporating one or more halogen elements such as fluorine or chlorine, as well as other non-metal elements such as phosphorus, and semimetal elements including boron, for example. In some embodiments, the salts may include any lithium-containing material that may be soluble in organic solvents. The solvents included with the lithium-containing salt may be organic solvents, and may include one or more carbonates. For example, the solvents may include one or more carbonates including propylene carbonate, ethylene carbonate, ethyl methyl carbonate, dimethyl carbonate, diethyl carbonate, and fluoroethylene carbonate. Combinations of solvents may be included, and may include for example, propylene carbonate and ethyl methyl carbonate as an example combination. Any other solvent may be included that may enable dissolving the lithium-containing salt or salts as well as other electrolyte component, for example, or may provide useful ionic conductivities.

The separator may be wetted with the electrolyte, such as a fluid electrolyte or gel electrolyte, to incorporate the electrolyte into the stacked battery. Alternatively, a gel electrolyte may coat the separator. Additionally, the electrolyte may be blended with particles of electrode active material. In various embodiments, incorporating the electrolyte into the components of the stacked battery may reduce gassing in the stacked battery. In variations that include a flexible seal, the stacked battery may accommodate gas resulting from degassing.

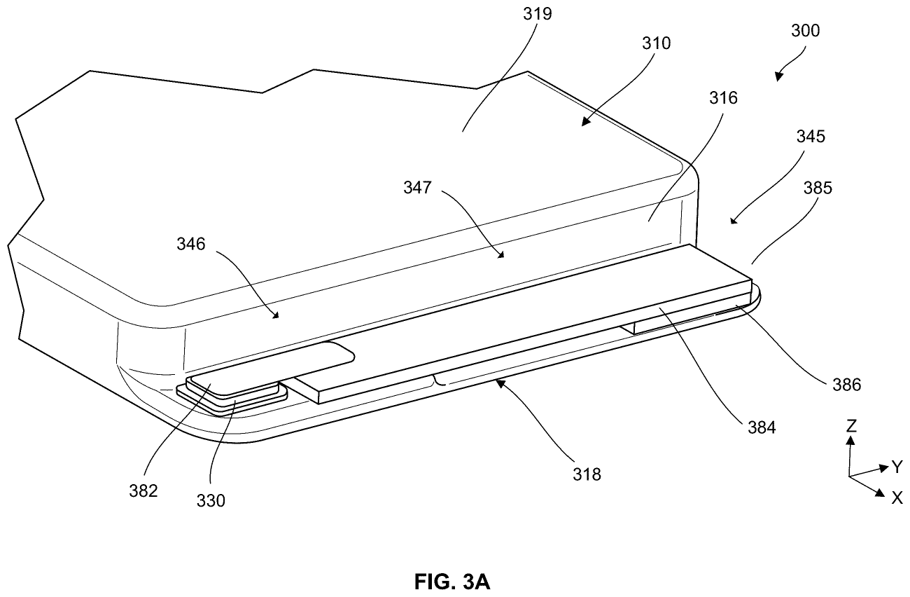

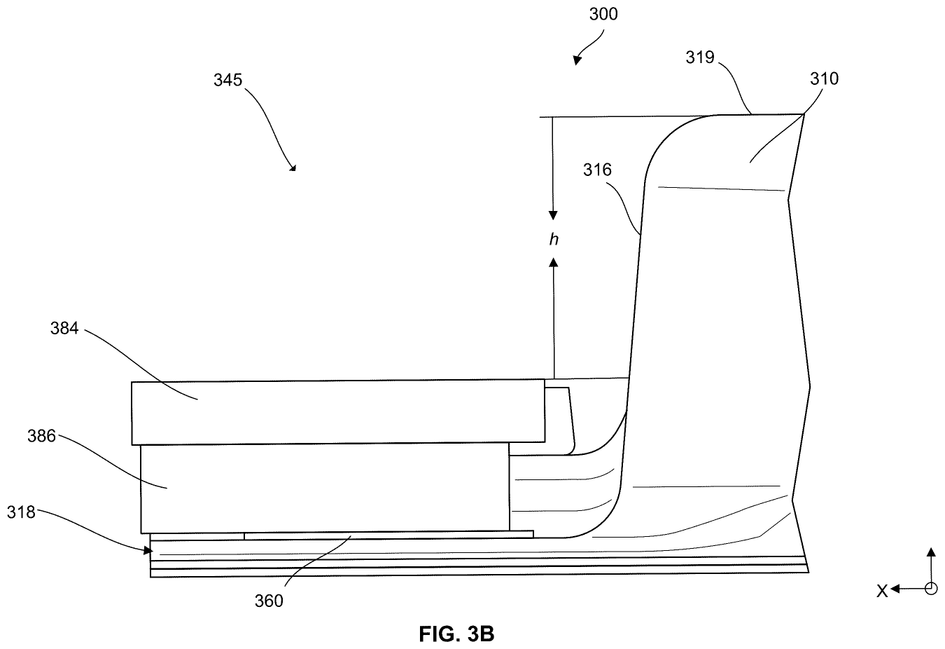

As noted above, various components may be positioned in the pathway 245 on the ledge 218. Such components may be coupled on the ledge 218 along the X-Y plane such that the width of those components are not tied to a height of the battery housing 210, therefore allowing for those components and the battery housing 210 to have greater design customization. For example, FIGS. 3A and 3B depict an example battery 300 with various pathway electronic components (e.g., electronic components positioned in the pathway of the battery 300). FIG. 3A depicts a perspective view of an example battery according to an aspect of the disclosure. FIG. 3B depicts a side view of the battery of FIG. 3A. It is understood that features ending in like reference numerals as features discussed above are similar, except as noted below. The battery 300 may include a ledge coupled to a first component 382, second component 384, and third component 386 in the pathway 345. It should be understood that the dimension of the components 382, 384, 386 depicted in the figures are for illustrative purposes only. Further, in other embodiments, more or less components may be positioned in the pathway 345 along the ledge 318, such as additional spacers or the like. As noted above, the components 382, 384, 386 may be one or more of a printed circuit board (PCB), battery management unit (BMU), wires, or the like. For example, the first component 382 may be a positive electrode tab coupled to the electrical contact 230 (e.g., via laser welding or the like). In this manner, other components may electrically couple with the electrical contact 230 through the first component 382. The second component 384 may be a BMU. The third component 386 may be a negative tab extension extending from the negative tab 360 (e.g., a folded metal conductive component) such that other components may electrically couple with the negative electrode tab 360 through the third component 386. In other embodiments, the components may each be different components, or may include one or more other components.

As noted above, in other embodiments without a ledge, one or more components may be coupled along the sidewall of the battery housing. With reference to the features of FIGS. 3A and 3B for explanatory purposes, in those other embodiments, components may be coupled to the battery housing 310 along the sidewall 316 such that those components (e.g., the components 382, 384, 386) lie against the sidewall 316 along the Y-Z plane. In this configuration, the dimensions of those components may be tied to the dimension of the sidewall 316. Specifically, the width of those components (e.g., along the Z-direction) may limit how small the battery housing 310 may be along the Z-direction. In particular, this may be an issue where the battery housing 310 is a can housing prismatic cells as the electrode tabs may lie against the sidewall 316, which may lead to the electrical components coupled to the battery housing 310 to lie along the sidewall 316 (e.g., along the sidewall 316 on a Y-Z plane).

The ledge 318 of the present disclosure addresses this issue by allowing for the height of the battery housing 310 along the Z-direction to be more easily adjusted without having to account for a width of the components 382, 384, 386. Instead, the height of the battery housing 310 may be decreased to a minimum length corresponding to the height of all the components 382, 384, 386 stacked on the ledge 318 along the Z-direction. Alternatively, additional components may be positioned in the pathway 345 without increasing the overall height of the battery housing 310.

For example, turning specifically to FIG. 3B, the battery 300 may define a height h between a top surface 319 of the battery housing 310 and a top surface 385 of the second component 384. Where it is not desired to stack other components on top of the second component 384 upwards along the Z-direction, the height of the battery housing 310 may be decreased as desired by a height up to height h. In other embodiments, one or more components may be positioned in the pathway 345 on the ledge 318 up to height h. In yet other embodiments, the height of the battery housing may be decreased further where the height of the components are decreased, such as to the height of the first electrical contact. In some embodiments, there may be more one or more components coupled on the ledge only in one of the first portion (e.g., the first portion 346) or the second portion (e.g., the second portion 347) of the pathway but not the other portion. Further, the components in the second portion 347 may include a total stacked height along the Z-direction greater than the first portion 346 as the second portion 347 includes a larger height than the first portion 346.

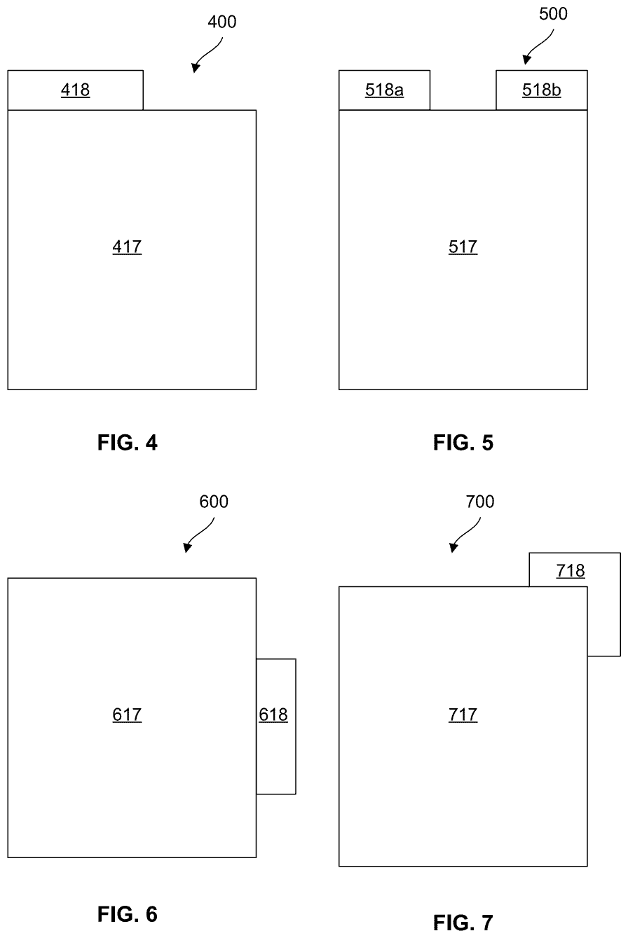

Although the batteries 200, 300 includes one ledge 218, 318 along an entire side of the battery housing 210, 310, other configurations are envisioned. For example, FIGS. 4-7 depict example batteries 400-700 include ledges 418-718 at various positions and with various shapes. It is understood that features ending in like reference numerals as features discussed above are similar, except as noted below. For example, the ledges 418-718 may have any shape, and configuration of plateau and valley portions as described for the ledge 218. FIG. 4 depicts a simplified, top view of an example battery according to an aspect of the disclosure. The battery 400 may include a ledge 418 having a length less than a total length of a side of the main portion 417. Specifically, the ledge 418 may extend from a corner of the main portion 417 along only a portion of a side of the main portion 417. In other words, the ledge 418 may have a maximum length less than a maximum length of the side of the main portion 417 that the ledge 418 extends from. FIG. 5 depicts a simplified, top view of an example battery according to an aspect of the disclosure. The battery 500 may include multiple ledges 518a, 518b extending from the main portion 517. In other embodiments, there may be any number of ledges extending from the main portion, such as more than two ledges. FIG. 6 depicts a simplified, top view of an example battery according to an aspect of the disclosure. The battery 600 may include a ledge 618 extending from an intermediate section of a side of the main portion 617. In other embodiments, the ledge may extend from any portion of the side of the main portion. FIG. 7 depicts a simplified, top view of an example battery according to an aspect of the disclosure. The battery 700 may include a ledge 718 extending from a corner of the main portion 717 such that the ledge 718 extends from two sides of the main portion 717 (e.g., the ledge 718 wraps around a corner of the main portion 717). In other embodiments, the ledge may extend from a corner of the main portion and extend only from one side of the main portion. In another embodiment, the ledge may extend from a corner of the main portion and may not extend from any side of the main portion (e.g., the ledge is coupled to the main portion only along the corner of the main portion). In yet other embodiments, the ledge may include any one or more features of the ledge configurations as noted above (e.g., there may be multiple ledges extending from an intermediate section of a side of the main portion, there may be multiple ledges wrapping around multiple corners of the main portion, or the like).

In other embodiments, the battery may include an internal electrical contact with a laminated insulation layer. FIG. 8 depicts a simplified, top view of an example battery according to an aspect of the disclosure. It is understood that features ending in like reference numerals as features discussed above are similar, except as noted below. The battery 800 may include an electrical contact 830 (similar to the electrical contact 230) electrically coupled to an electrode stack (not shown) through a laminated electrical contact 824. The laminated electrical contact 824 may include a conductive layer 828 and an insulation layer 829. The conductive layer 828 may be electrically coupled to an electrode stack (not shown). The electrical contact 830 and the conductive layer 828 may be coupled together such that the electrode stack may provide electrical charge to the electrical contact 830 through the conductive layer 828. For example, the electrical contact 830 may be compressed against the conductive layer 828 in a Z-direction to ensure that there is contact between the electrical contact 830 and the conductive layer 828. In other embodiments, the electrical contact 830 and the conductive layer 828 may additionally or alternatively be coupled together with a conductive adhesive. The conductive layer 828 may include one or more electrically conductive materials, as discussed above. The insulation layer 829 may include one or more electrically insulative materials, as discussed above (e.g., rubber, PB, PFA, PBS, or the like). As noted above, the laminated electrical contact 224 may replace one or more components of batteries of other embodiments, such as the conductive component 271, electrical contact 224, and internal gasket 222 of the battery 200.

The insulation layer 829 may be laminated to the conductive layer 828 such that the shape of the layers 828, 829 conform to each other. In other words, the shape of the laminated electrical contact 824 may be changed and manipulated as desired without the layers 828, 829 separating from each other. For example, as shown in FIG. 8, the shape of the laminated electrical contact 824 may be manipulated such that a portion of the laminated electrical contact 824 conforms to a non-planar portion of an interior surface of the battery housing 810 (e.g., along a corner of the battery housing 810). At the same time, because the insulation layer 829 is laminated to the conductive layer 828, the insulation layer 829 conforms to the shape of the conductive layer 828. In this manner, the insulation layer 829 may always be coupled between the conductive layer 828 and the battery housing 810 to minimize the risk that the conductive layer 828 contacts the battery housing 810. To further minimize the risk the conductive layer 828 contacts the battery housing 810, the laminated electrical contact 824 may curve or angle away from the interior surface of the battery housing 810, defining a space 823 between the insulation layer 829 and the interior surface of the battery housing 810, such that the laminated electrical contact 824 is no longer in contact with the interior surface of the battery housing 810. The laminated insulation layer 829 may be particularly helpful where sudden movement of the battery housing 810 may cause a corresponding sudden movement of the laminated electrical contact 824. Since the insulation layer 829 is laminated to the conductive layer 828 such that the insulation layer 829 conforms to the shape of the conductive layer 828 and is always coupled between the conductive layer 828 and the battery housing, the conductive layer 828 will not contact the battery housing 810.

The lamination configuration of the layers 828, 829 may also allow for greater flexibility in the design of the battery housing 810 as the shape of the battery housing 810 may be designed without being limited by the shape of the electrical tab 824 or additional gaskets that may otherwise be positioned in the battery housing 810. Further, this requires less insulation components housed in the battery housing 810 as, instead of multiple internal gaskets, insulation plates, spacers, or the like, the insulation layer 829, by itself, may be sufficient to electrically insulate the conductive layer 828 from the battery housing 810. This decrease in insulation components may also allow the battery housing 810 to be thinner (e.g., smaller along the Z-direction) as well as decrease material costs.

The insulation layer 829 may be laminated to the conductive layer 828 through an adhesive, heat lamination, coating (e.g., spray coating), or the like. The insulation layer 829 may also be adhered or heat laminated to the interior surface of the battery housing 810. In yet other embodiments, the insulation layer may be coupled to the conductive layer through being compressed between the conductive layer and the battery housing.

In some embodiments, the laminated electrical contact 824 may be malleable such that the laminated electrical contact 824 may change its shape through being pressed against the battery housing 810. This may allow for easier manufacturing as the shape of the battery housing 810 may be designed as desired first and then the laminated electrical contact 824 may be pressed against the battery housing 810 to conform to the shape of the battery housing 810. However, in other embodiments, the laminated electrical contact may be formed by first sheet molding the conductive layer to the portion of the interior surface of the battery housing that the laminated electrical contact will be positioned against. The insulation layer will then be laminated onto the conductive layer (e.g., heat-lamination, coating, adhesion, or the like). Such a sheet molding and lamination process may be cheaper, overall, than manufacturing a battery by manufacturing additionally components (e.g., gaskets and spacers) through injection molding.

In the foregoing specification, embodiments of the disclosure have been described with reference to numerous specific details that can vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction. The specific details of particular embodiments can be combined in any suitable manner without departing from the spirit and scope of embodiments of the disclosure.

Additionally, spatially relative terms, such as “bottom or “top” and the like can be used to describe an element and/or feature's relationship to another element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as a “bottom” surface can then be oriented “above” other elements or features. The device can be otherwise oriented (e.g., rotated 90 degrees or at other orientations) and the spatially relative descriptors used herein interpreted accordingly.

Terms “and,” “or,” and “an/or,” as used herein, may include a variety of meanings that also is expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, B, C, AB, AC, BC, AA, AAB, ABC, AABBCCC, etc.

Reference throughout this specification to “one example,” “an example,” “certain examples,” or “exemplary implementation” means that a particular feature, structure, or characteristic described in connection with the feature and/or example may be included in at least one feature and/or example of claimed subject matter. Thus, the appearances of the phrase “in one example,” “an example,” “in certain examples,” “in certain implementations,” or other like phrases in various places throughout this specification are not necessarily all referring to the same feature, example, and/or limitation. Furthermore, the particular features, structures, or characteristics may be combined in one or more examples and/or features.

In some implementations, operations or processing may involve physical manipulation of physical quantities. Typically, although not necessarily, such quantities may take the form of electrical or magnetic signals capable of being stored, transferred, combined, compared, or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining,” or the like refer to actions or processes of a specific apparatus, such as a special purpose computer, special purpose computing apparatus or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter. Therefore, it is intended that claimed subject matter not be limited to the particular examples disclosed, but that such claimed subject matter may also include all aspects falling within the scope of appended claims, and equivalents thereof.

What is claimed is:

1. A battery, comprising:
a battery can housing including a main portion and a ledge, wherein the ledge extends from a sidewall of the main portion at a transverse angle to the sidewall;
an electrode stack housed within the main portion; and
an electrical contact electrically coupled to the electrode stack, wherein a portion of the electrical contact extends from the ledge at the transverse angle to the sidewall.

2. The battery of claim 1, wherein:
the ledge includes a plateau portion and a valley portion;
the plateau portion includes a greater height from a base of the battery can housing than the valley portion.

3. The battery of claim 2,
further comprising a second electrical contact, and
wherein:
the electrical contact is a first electrical contact;
the first electrical contact extends from a first aperture defined by the plateau portion; and
the second electrical contact extends from a second aperture defined by the valley portion.

4. The battery of claim 1, wherein the sidewall includes a first maximum length greater than a second maximum length of the ledge.

5. The battery of claim 4, wherein the ledge extends from an intermediate portion of the sidewall.

6. The battery of claim 1, wherein the ledge is a first ledge of a plurality of ledges.

7. The battery of claim 1, wherein the ledge extends from a corner of the main portion.

8. A battery, comprising:
a battery can housing including a main portion and a ledge, wherein the ledge extends from a sidewall of the main portion at a transverse angle to the sidewall;
an electrode stack housed within the main portion; and
an electrode tab electrically coupled to the electrode stack, wherein a portion of the electrode tab extends from the ledge at the transverse angle to the sidewall.

9. The battery of claim 8, wherein:
the ledge includes a plateau portion and a valley portion;
the plateau portion includes a greater height from a base of the battery can housing than the valley portion.

10. The battery of claim 2,
further comprising a second electrode tab, and
wherein:
the electrical contact is a first electrode tab;
the first electrode tab extends from a first aperture defined by the plateau portion; and
the second electrode tab extends from a second aperture defined by the valley portion.

11. The battery of claim 8, wherein the sidewall includes a first maximum length greater than a second maximum length of the ledge.

12. The battery of claim 4, wherein the ledge extends from an intermediate portion of the sidewall.

13. The battery of claim 8, wherein the ledge is a first ledge of a plurality of ledges.

14. The battery of claim 8, wherein the ledge extends from a corner of the main portion.

15. A battery system, comprising:
a battery, comprising:
a battery can housing including a main portion and a ledge, wherein the ledge extends from a sidewall of the main portion at a transverse angle to the sidewall;
an electrode stack housed within the main portion; and
a conductive component electrically coupled to the electrode stack, wherein a portion of the conductive component extends from the ledge at the transverse angle to the sidewall; and
a battery management unit electrically coupled to the conductive component.

16. The battery system of claim 15, further comprising an electronic component electrically coupled to the conductive component and positioned on the ledge at the transverse angle to the sidewall.

17. The battery system of claim 15,
further comprising a second conductive component, and
wherein:
the ledge includes a plateau portion and a valley portion;
the plateau portion includes a greater height from a base of the battery can housing than the valley portion;
the conductive component is a first conductive component;
the first conductive component extends from a first aperture defined by the plateau portion; and
the second conductive component extends from a second aperture defined by the valley portion.

18. The battery system of claim 15, wherein the sidewall includes a first maximum length greater than a second maximum length of the ledge.

19. The battery system of claim 15, wherein the ledge is a first ledge of a plurality of ledges.

20. The battery system of claim 15, wherein the ledge extends from a corner of the main portion.
